(19) United States
(12) Patent Application Publication
(10) Pub. No.: US 2015/0365390 A1
(43) Pub. Date: Dec. 17, 2015

(54) METHOD OF CREATING PREFERENCE IMAGE IDENTIFICATION CODE, METHOD OF DIAGNOSING PREFERENCE IMAGE IDENTIFICATION CODE, AND METHOD OF PROVIDING INFORMATION USING PREFERENCE IMAGE IDENTIFICATION CODE

(71) Applicant: Mi-Sun KONG, (US)

(72) Inventor: Mi-Sun KONG, Busan (KR)

(21) Appl. No.: 14/764,536

(22) PCT Filed: Jan. 23, 2014
(86) PCT No.: PCT/KR2014/000668

§ 371 Date: Jul. 29, 2015

(30) Foreign Application Priority Data
Jan. 30, 2013 (KR) 10-2013-0010565

(51) Int. Cl. H04L 29/06; H04W 12/06

(52) U.S. Cl. CPC H04L 63/08; H04W 12/06

(57) ABSTRACT

Disclosed are a method of creating a preference image identification code, a method of diagnosing the preference image identification code, and a method of providing information using the preference image identification code.

The preference image identification code is an identification code for public utilization by collecting, segmenting, and digitizing at least one image.

Information is provided through information search, and in the form of location-based information, and comparison and diagnosis information. The information is provided step by step according to the similarity level, or provided through a visual scheme and/or acoustic scheme. The provision of the information is set suitably for the request object and need for the information by a user.

### TECHNICAL FIELD

The present invention relates to a system for creating and diagnosing a preference image identification code. More particularly, the present invention relates to a system and a method of creating a quantative and public preference image identification code by segmenting an emotional preference image and diagnosing the preference image identification code, and a system and a method of providing information.

### BACKGROUND ART

Preference images are subject data used in a field requiring emotion. In general, the preference image has been utilized as a material to compare and analyze images by overlaying the images in a product planning and marketing field. The preference image is created through a qualitative work. When the created image is used to candidate a product, the image has been utilized only through the technology matched with the attribute of a target.

However, recently, in a market that the emotional field is enlarged, a specific identification code may be a means for providing information if the preference image is created in the form of the specific identification code, which is differentiated, as well as the form of data. If the preference image is utilized for providing information, the user may be provided with information more appropriate to the preference of the user.

Accordingly, there are required a technology of reasonably and objectively performing a process of creating a preference image, a method of creating a preference image identification code, and effective information matching based on the technology and the method.

As a related art of the invention, there is a Korean Patent Registration No. 10-0687906 tilted “Product Recommendation System and Method for the same” (issued on Feb. 27, 2007).

### DISCLOSURE

### Technical Problem

An object of the present invention is to create a segmented preference image identification code by extracting data of an emotional image in order to create an objective and quantative preference image, schematizing a clustering process on a position map, extracting factors constituting the preference image identification code, and combining the factors with each other.

Another object of the present invention is to develop a system for creating a preference image identification code by creating a preference image utilized for a preference image identification code through a quantative process and providing a process of collecting the preference image to an objective system, and for diagnosing the preference image identification code.

Still another object of the present invention is to provide a method and a system for variously providing information to provide selectively customized information so that the information can be efficiently provided online/offline by utilizing a preference image identification code while the time and the effort of a user can be saved.

### Technical Solution

In order to accomplish the above objects, a system for creating a preference image identification code according to an exemplary embodiment of the present invention includes at least one server having an input/output module and an operation module, a database connected with the at least one server to serve as a user authentication and information storage module, at least one user terminal, and a wire/wireless communication network to connect the at least one server with the at least user terminal. The at least one server receives information of each of the at least one user terminal from the at least user terminal through the input/output module, performs user authentication, and stores relevant information in the database. The at least one server receives a target range and a category for information provision set based on information of a tangible/intangible product target including a person, a store, or a brand and related to the preference image identification code to be created and information of a component of the target from the at least one user terminal through the input/output module, collects at least one image information of an emotional word, an association word associated with the emotional word, and an image from the at least one server or the at least one user terminal based on the received target range and the category, and receives the number of preference images to be created from the at least one user terminal. The operation module clusters the collected image information on a positioning coordinate image, positions a preference image on the coordinate image having clustering, and determines the position of the preference image. The operation module creates the preference image identification code from the positioned preference image and stores the preference image. The created preference image identification code is stored in the database. The image information is collected through at least one input scheme among an input based on a question or a questionnaire, an input based on a bar code, and at least one of a two dimensional code or a three dimensional code, and an input by the at least one server or the at least one user terminal.

In order to solve the above objects, a method of creating a preference image identification code according to an exemplary embodiment of the present invention employs a system for creating the preference image identification code, which includes at least one server having an input/output module and an operation module, a database connected with the at least one server to serve as a user authentication and information storage module, at least one user terminal, and a wire/wireless communication network to connect the at least one server with the at least user terminal. The method includes (A) allowing the at least one server to receive information of each of the at least one user terminal from the at least user terminal through the input/output module, perform user authentication, and store relevant information in the database, (B) allowing the at least one server to receive a target range and a category for information provision set based on information of a tangible/intangible product target including a person, a store, or a brand and related to the preference image identification code to be created and information of a component of the target from the at least one user terminal through the input/output module, (C) allowing the at least one server to collect at least one image information of an emotional word, an association word associated with the emotional word, and an image from the at least one server or the at least one user terminal based on the target range and the category, (D) receiving a number of preference images to be created from the at least one user terminal, (E) allowing the operation module to cluster the collected image information on a positioning coordinate image, to position a preference image on the coordinate image having clustering, and to determine the position of the preference image, and (F) allowing the operation module to create the preference image identification code from the positioned preference image and to store the preference image. In the step (C), the image information is collected through at least one input scheme among an input based on a question or a questionnaire, an input based on a bar code, and at least one of a two dimensional code or a three dimensional code, and an input by the at least one server or the at least one user terminal.

In this case, preferably, the step (F) includes allowing the operation module to create the preference image identification code by extracting at least one broadly classified image serving as a representative image of a coordination axis closest to coordinates of the positioned preference image and determined using at least one of the emotional word, the association word associated with the emotional word, and the image, a virtual line mark to represent virtual line setting and a virtual line directionality, an attribute value of the preference image, and an attribute of the target from the positioned preference image and then by combining at least one of them with each other.

In addition, preferably, the step (F) of creating the preference image identification code, when the broadly classified image is extracted using any one of the association word and the image, the preference image ID code maybe created by individually using the associated word or the image, or may be created through the combination of at least one of the association word, the image, the virtual line mark to represent virtual line setting and a virtual line directionality, the attribute value of the preference image, and the attribute value of the target.

Further, preferably, the method further includes (G) creating a compatible identification code compatible with the preference image in the set category based on the created preference image identification code, and creating at least one of an electronic auxiliary identification code including at least one individual identification information of the tangible/intangible product including the person, the store, and the brand, and/or created by additionally containing the sequence of the same preference images and other individual information, and utilized online/offline, and hardware-type signboard and physical signboard information including information of the electronic auxiliary identification code, from the preference image identification code or the compatible identification code.

In order to accomplish the above objects, a system for diagnosing a preference image identification code according to an exemplary embodiment of the present invention is to diagnose the preference image identification code created in the above-described system for creating the preference image identification code in which the operation module provides at least one of information of at least one of the created preference image identification code, the electronic auxiliary identification code, the information of the hardware-type signboard and physically auxiliary signboard including information of the electronic auxiliary identification code, and the compatible identification code and visualization information of the information such that the at least one of the created preference image identification code, the electronic auxiliary identification code, the information of the hardware-type signboard and physically auxiliary signboard including information of the electronic auxiliary identification code, and the compatible identification code is diagnosed in the user terminal.

In order to accomplish the above objects, a method of diagnosing a preference image identification code according to an exemplary embodiment of the present invention is to diagnose the preference image identification code created according to the above-described method of creating the preference image identification code, in which the operation module provides at least one of information of at least one of the created preference image identification code, the electronic auxiliary identification code, the information of the hardware-type signboard and physically auxiliary signboard including information of the electronic auxiliary identification code, and the compatible identification code and visualization information of the information such that the at least one of the created preference image identification code, the electronic auxiliary identification code, the information of the hardware-type signboard and physically auxiliary signboard including information of the electronic auxiliary identification code, and the compatible identification code is diagnosed in the user terminal.

In this case, preferably, the diagnosis information of the preference image identification code is stored in the database of the at least one server.

In order to accomplish the above objects, a system for creating a preference image identification code according to an exemplary embodiment of the present invention includes at least one server having an input/output module and an operation module, a database connected with the at least one server to serve as a user authentication and information storage module, at least one user terminal, and a wire/wireless communication network to connect the at least one server with the at least user terminal. The at least one server receives information of each of the at least one user terminal from the at least user terminal through the input/output module, performs user authentication, and stores relevant information in the database. The at least one server receives a target range and a category for information provision set based on information of a tangible/intangible product target including a person, a store, or a brand and related to the preference image identification code to be created and information of a component of the target from the at least one user terminal through the input/output module, collects at least one image information of an emotional word, an association word associated with the emotional word, and an image from the at least one server or the at least one user terminal based on the received target range and the category, and receives the number of preference images to be created from the at least one user terminal. The operation module clusters the collected image information on a positioning coordinate image, positions a preference image on the coordinate image having clustering, and determines the position of the preference image. The operation module creates the preference image identification code from the positioned preference image and stores the preference image. The image information is collected through at least one input scheme among an input based on a question or a questionnaire, an input based on a bar code, and at least one of a two dimensional code or a three dimensional code, and an input by the at least one server or the at least one user terminal.

In order to solve the above objects, a method of creating a preference image identification code according to an exemplary embodiment of the present invention employs a system for creating the preference image identification code, which includes at least one server having an input/output module and an operation module, a database connected with the at least one server to serve as a user authentication and information storage module, at least one user terminal, and a wire/wireless communication network to connect the at least one server with the at least user terminal. The method includes (A) allowing the at least one server to receive information of each of the at least one user terminal from the at least user terminal through the input/output module, perform user authentication, and store relevant information in the database; to receive a target range and a category for information provision set based on information of a tangible/intangible product target including a person, a store, or a brand and related to the preference image identification code to be created and information of a component of the target from the at least one user terminal through the input/output module; to collect at least one image information of an emotional word, an association word associated with the emotional word, and an image from the at least one server or the at least one user terminal based on the target range and the category; and to receive a number of preference images to be created from the at least one user terminal, and (B) allowing the operation module to cluster the collected image information on a positioning coordinate image; to position a preference image on the coordinate image having clustering; to determine the position of the preference image; to create the preference image identification code from the positioned preference image; and to store the preference image. The image information is collected through at least one input scheme among an input based on a question or a questionnaire, an input based on a bar code, and at least one of a two dimensional code or a three dimensional code, and an input by the at least one server or the at least one user terminal.

The details of other embodiments are contained in the detailed description and accompanying drawings.

The advantages, the features, and schemes of achieving the advantages and features of the disclosure will be apparently comprehended by those skilled in the art based on the embodiments, which are detailed later in detail, together with accompanying drawings. The present invention is not limited to the following embodiments but includes various applications and modifications. The embodiments will make the disclosure of the present invention complete, and allow those skilled in the art to completely comprehend the scope of the present invention. The present invention is only defined within the scope of accompanying claims.

The same reference numerals are assigned to the same elements throughout the specification, and sizes, positions, and coupling relationships of the elements may be exaggerated for clarity.

### Advantageous Effects

Accordingly, the differentiated, segmented, semi-fixed preference image identification code is created thereby creating the identification code that can be easily determined the preference of the target and designated. Accordingly, the preference image identification code can be utilized as personal and individual information for a predetermined period of time, so that the preference image identification code can be usefully used in E-commerce, marketing, and content fields.

In addition, a person and a company can reasonably create the preference image identification code, so that the creation result can be conveniently provided as information or verified and diagnosed in the form of visual information.

In addition, information can be received by utilizing the created preference image identification code as a search word, and the auxiliary signboard of the store including the electronic auxiliary identification code is created by utilizing the preference image identification code, in the saturated environment that various products, various custom preferences, a dense area in which a plurality of online or offline stores exist, a plurality of online communities, so that information can be directly requested.

Further, the location-based information and comparison and diagnosis information including a step-by-step notification service based on a similarity level matched with the preference image identification code can be received, so that the differentiated and customized information can be received.

### DESCRIPTION OF DRAWINGS

FIG. 1 is a block diagram schematically showing a system for creating a preference image ID code according to an exemplary embodiment of the present invention.

FIG. 2 is a flowchart schematically showing a method of creating a preference image identification code according to the exemplary embodiment of the present invention.

FIG. 3a illustrates a plot showing the coordinate axis and the collected preference image provided through the method of creating the preference image ID code according to the exemplary embodiment of the present invention. FIG. 3b illustrates images clustered through the method of creating the preference image ID code according to the exemplary embodiment of the present invention. FIG. 3c illustrates the broadly classified image created based on the clustered image, and an image to set the mark to represent the virtual line and the virtual line directionality, and to extract the attribute value of the preference image through the method of creating the preference image ID code according to the exemplary embodiment of the present invention.

FIG. 4 is a flowchart schematically showing a method of providing information according to the exemplary embodiment of the present invention.

### BEST MODE

### Mode for Invention

Hereinafter, embodiments of the present invention will be described in detail with reference to accompanying drawings. In the following description, steps to realize a method according to an exemplary embodiment of the present invention will be described. If the detailed sequence of the steps is not specified, the steps maybe performed in the sequence different from the disclosed sequence. For example, the proceeding sequence of the steps maybe made in opposition to the disclosed sequence, the subsequent step may be performed after some intermediate steps are omitted, or several steps may be simultaneously performed.

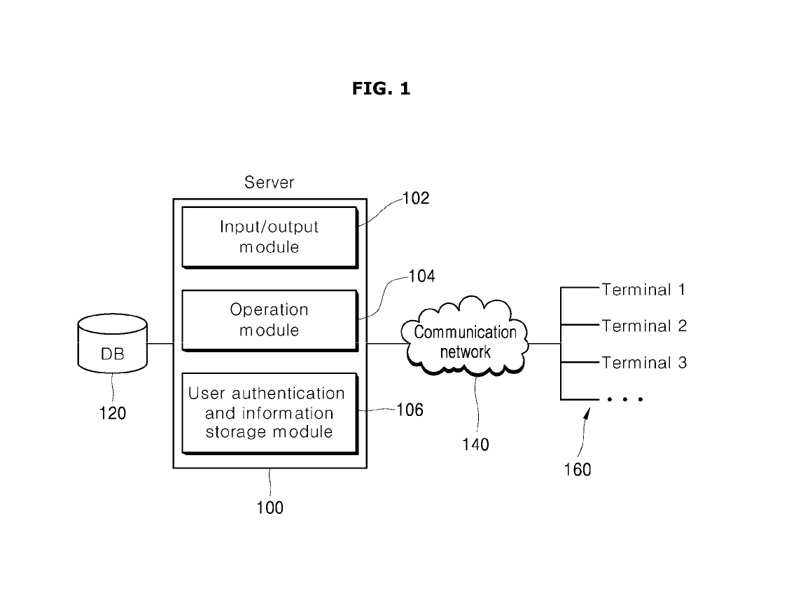

FIG. 1 is a block diagram schematically showing a system for creating a preference image identification (ID) code according to an exemplary embodiment of the present invention.

As shown in FIG. 1, the system for creating the preference image ID code according to the exemplary embodiment of the present invention includes a server 100, a database (DB) 120 which is in charge of processes related to data of the server 100, a communication network 140, and a user terminal module 160 including at least one terminal (terminal 1, terminal 2, terminal 3, . . . , and terminal N). According to the present invention, although FIG. 1 shows only one server 100, those skilled in the art can understand that several servers 100 simultaneously operate in several places. Similarly, it can be understood that a plurality of DBs 120 are provided.

In this case, the server 100 preferably further includes an input/output module 102, an operation module 104, and a user authentication and information storage module 106. The communication network 140 is in charge of communication between the server 100 and the user terminal module 160. Although the server 100 and the user terminal module 160 may be directly connected with each other in a wire/wireless scheme, they may be more preferably connected with each other through the Internet or Intranet.

In addition, although the user terminal module 160 is preferably a personal computer (PC), the user terminal module 160 may include a laptop computer, an IPTV, a cellular phone including a smart phone, or a dedicated terminal device. In the case of the IPTV or the smart phone, the communication network preferably has the form of the Internet or the Intranet, which may include a wireless network, such as WiFi, Wibro, or Bluetooth.

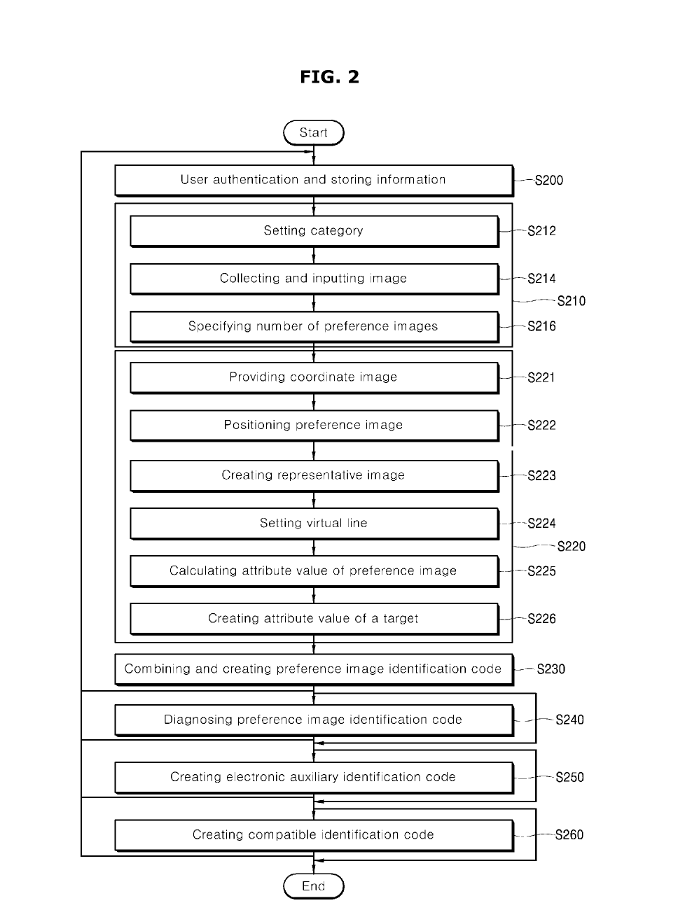

The input/output module 102 may make wire/wireless communication with the user terminal module 160, and may be in charge of input and output inside the server 100. The operation module 104 performs various operations of combining and creating preference image ID codes according to the exemplary embodiment of the present invention to be described. The details of the operations will be described with reference to FIG. 2. The user authentication and information storage module 106 may store user authentication information and user related information in the form of personal information according to an exemplary embodiment of the present invention.

For reference, the input and output process according to the present invention includes a typical input and output process. It should be understood that a process of inputting personal information by a user, a process of marking a preference image ID code in the form of coordinates in a step of diagnosing the preference image ID code (see S240 of FIG. 2), a process of calling a preference image ID code created from a DB installed in another server to store the preference image ID code in the server 100 or the DB 120 according to the present invention, and a process of transmitting the preference image ID code to the user terminal module 160 is one of input and output processes.

FIG. 2 is a flowchart schematically showing a method of creating a preference image ID code according to the exemplary embodiment of the present invention.

Referring to FIG. 2, the method of creating the preference image ID code may include a step of storing user authentication and information (S200), a step of inputting preference image information (S210) including a step of setting a category (S212), a step of collecting and inputting an image (S214), and a step of specifying the number of preference images (S216). In this case, authentication information required in each step may be input from the user through the user terminal module 160.

Next, a step of creating factors constituting the preference image (S220) may include a step of clustering image information to provide a coordinate image (S221), a step of positioning the preference image (step S222), a step of creating a broadly classified image in the structure of a positioning map (S223), a step of setting a virtual line (S224), a step of calculating an attribute value of the preference image (S225), and a step of creating an attribute value of a target (S226). The operation in each step is preferably performed by an operation extracting module 104.

Then, the user may be assigned with the preference image ID code in a step of combining and creating the preference image ID code (S230) depending on information input in the step of inputting image information (S210).

In this case, it should be recognized that the preference image ID code is an identification code obtained by collecting, segmenting, and digitizing at least one image for the use of the public.

In addition, the method of creating the preference image ID code according to the exemplary embodiment of the present invention may further include a step of diagnosing the preference image ID code (step S240), a step of creating an electronic auxiliary ID code (S250), and a step of creating an auxiliary signboard containing information of the electronic auxiliary ID code (not shown), and a step of creating a compatible ID code (S260).

Hereinafter, the steps shown in FIG. 2 will be described in more detail.

According to the step of storing user authentication and information (S200), demographic information of a user, which serves as an individual ID information of a tangible/intangible product including a person, a store, or a brand, information of a firm name, a phone number, a serial number of a wire/wireless terminal, an e-mail, and the like maybe registered, the created preference image ID code (see S230) may be stored, registered, and managed. In this case, the information necessary for the user authentication may be information input from the user terminal module 160, and maybe input through the communication network 140.

The step of setting the category (S212) constituting the step of inputting preference image information (S210) is a step of setting the category of the image. Images of tangible or intangible products including a person, a store, or a brand, and the detailed attributes thereof may be set. In addition, the images may be set by selecting any one of an image serving as an emotional word, an association word, a photo, and a picture.

In this case, the detailed attributes refer to an attribute of a target expressed as an image, and may include the outer appearance of a person, and the quality, the price, product components, the design, the color, the manufacturing, the distribution, the fashion, the trends, the brand name, the brand concept, the psychological research, the tendency, and the reaction of products including goods and services, which are tangible/intangible products.

Next, in the step of collecting and inputting an image (S214), the type of a collected image and a scheme of collecting the image may be varied depending on the result of the step of setting the category (S212). In this case, although it is preferred that images are preferably collected by extracting an adjective generally representing emotion, the images may be collected by extracting a word or an image associated with the emotional word.

In addition, the images according to the present invention include the intrinsic image to represent the characteristic of a user or a general image to express the intrinsic feeling of a target

As described above, in the step of collecting and inputting the image (S214) according to the present invention, information of a person, a store, a tangible/intangible product including a brand, and intangible service, such as tourism, a brand name, a brand concept, a music, learning, and human physiological response can be input.

In this case, generally, the images may be collected by asking a question, using a questionnaire, or inputting a 2D code or a 3D code, such as a bar code, a hot code, a QR code, or an RFID code, of a label having attributes reflected thereon and attached to a product. In addition, a user may input attributes, such as voice, outer appearances, letters, smells, or satisfactions, after recognizing/determining the attributes according to the subject feelings expressed by a target image. In addition, as described above, when the images have been already collected by another server, or when the collected images are stored in another database, the information of the images can be input.

Next, in the step of specifying the number of the preference images (S216) constituting the step of inputting the preference image information (S210), the number of the collected images to be created in the form of images emphasized according to use purposes or necessaries, that is, the preference images may be input because it is impossible to find out a main emphasis or the emphasis may be unclear when all collected images are created in the form of the preference images.

As described above, according to the method of the exemplary embodiment of the present invention, in the step of collecting and inputting an image (S214), a preference image having an enhanced image characteristic can be created based on an image which has been already created, and one preference image or at least one preference image can be crated based on a plurality of target attributes used to express the image. In this case, preference images may be clustered based on the target attributes, which is generally known to those skilled in the art, and the details thereof will be omitted.

Next, plural pieces of information of the input images are clustered in the step of creating factors constituting the preference image (S220), and the preference image is positioned (S222).

The present step of creating factors constituting the preference image (S220) is a step of clustering images based on image information input from the user and extracting the factors constituting the preference image ID code. In addition, it may be preferably understood that the present step is performed in the operation module 104 provided in the server 100.

In the step of providing the coordinate image (S221), and the step of positioning the preference image (step S222) according to the present invention, a positioning map in a multidimensional scaling (MDS) scheme may be utilized, which can be understood by those skilled in the art.

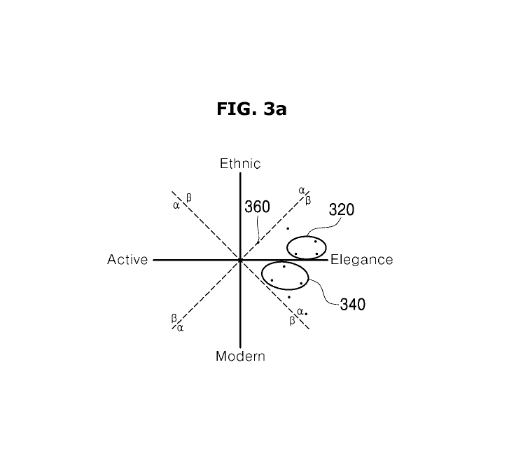

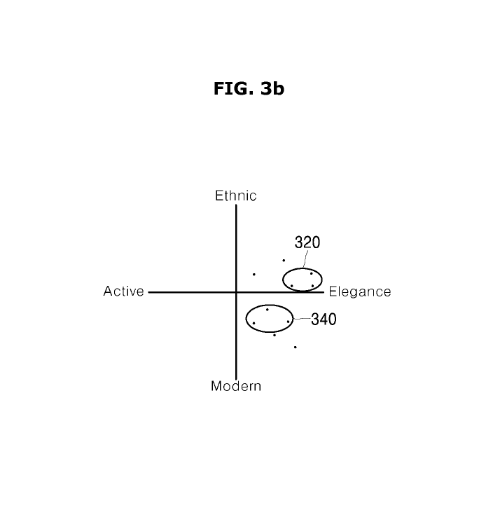

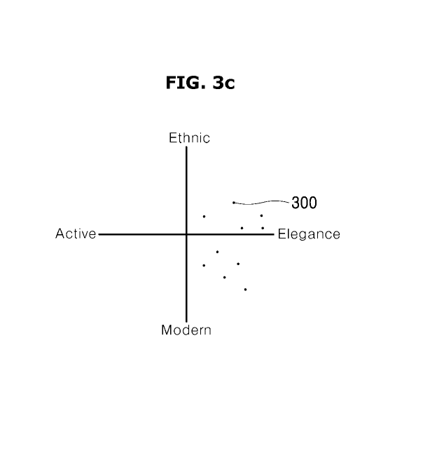

Although the broadly classified image may be created (see step S223 of FIG. 3C) through the above clustering, the broadly classified images are clustered and created using professional and subjective words. Accordingly, a representative image on a coordinate axis closest to the clustered preference image is preferably determined as the broadly classified image. As described above, the broadly classified image may be determined by selecting an emotional word, an association word, or a general image, such as a picture or a photo, which allows public communication.

Emotional products having various images and clustered on a coordinate axis may be provided with emotional words, such as “elegance”, “active”, “ethnic”, and “modern” (see FIG. 3A). In addition, more sub-divided coordinate axes (not shown), such as “romantic”, “sophisticate”, “mannish” and “country”, may be provided between coordinates.

Next, the preference image ID code maybe crated in the step of combining and creating the preference image ID code (S230) after the step of inputting the preference image information (S210) and the step of creating factors constituting the preference image (S220) have been performed. The preference image ID code can be created by creating the broadly classified image, a virtual line to divide the broadly classified image in half to produce left and right parts, a mark to represent the directionality of the virtual line, an attribute value of the preference image, and an attribute value of a target, and by combining at least one of the virtual line, the mark, the attribute value of the preference image, and the attribute value of the target. In this case, the preference image ID code obtained through the combination may be output to the user terminal module 160 through the input/output module 102, or may be stored in the database 120 provided in the server 100.

The preference image ID code created using the emotional word may be replaced with the association word, the picture, or the paint according to the utilization of the target or the objective of the target. The preference image ID code can be created by individually creating the association word, the picture, or the paint to represent the image or the preference factor, or by combining one or more association words, the picture, the paint, the virtual mark, and the attribute value of the image, which represent the image, and the attribute value of the target to represent the image.

For example, the emotional word of “elegance” may include a word of “elegance”, and maybe combined with various low-level attributes constituting the image, because the emotional words of the segmented image may be created by using subjective and professional words. Accordingly, if the emotional words are combined with object factors, the public communication is possible.

For example, if the axis of the broadly classified image exists on the elegance image, and if the different signs to represent the directionalities of alpha/beta, +/−, or a/b are combined with each other with respect to the elegance images divided into left and right halves, the ID codes including the directionalities segmented into an elegance alpha, an elegance beta, and the like can be created. In other words, through the combination, the elegance alpha, the elegance alpha 4.5, the elegance alpha 4.5 (level number), and the elegance M (level sign) can be obtained.

In addition, the word, the picture, or the photo associated with “Diana”, is individually applied to the emotional word of “elegance” or combined with other factors and applied to the emotional word of “elegance” to create Diana alpha, Diana alpha 4.5, and Diana M.

According to the step of calculating the attribute value of the preference image (S225, see FIG. 2), coordinates are made with respect to each of preference images, which are created in specific number, within a similar category based on a Euclidean distance value. Then, the contents of the broadly classified image are analyzed to extract the attribute value of each preference image based on the attribute. If two preference images (see reference numerals 320 and 340 of FIG. 3B) are created, the preference image, in which the characteristic of the broadly classified image is more emphasized, can be distinguished based on comparison attribute values of the broadly classified image. In addition, the numeric values of the created attributes may be expressed using a sign, a level numeric value, and a level sign so that the numeric values of the created attributes are not segmented. The details of the numeric values of the created attributes will be described below with reference to step S225 of FIG. 2.

In addition, when the preference image ID code is created, the attribute of the target to express the image is further included in the method, so that the preference image ID code can be obtained. The attribute of the target can be provided by selecting the type of the attribute in the category.

As described above, the preference image ID code having the combined attributes of the target may refer to an image concept ID code that can more segment and express the target as compared with the segmented preference image.

In addition, the image concept ID code may be selectively utilized, and may allow the public communication as the ID code is differentiated only if the preference image, such as the photo and the picture of the elegance or the Diana, is combined with a virtual line (alpha or beta).

For example, the attribute of the target of “elegance” or “Diana”, which the created preference image ID code, may be an attribute value to select a preference attribute among the attributes of the target to represent “Elegance” or “Diana” or to produce loyalty between sub-attributes constituting the preference attribute.

In this case, the loyalty can be calculated through Equation 1.

[Equation 1]

S=k×(P/T)

In Equation 1, S, k, and T denote the loyalty, a constant, a value obtained by adding weighted values to the sub-attributes included in the preference attribute after applying the weighted values to the sub-attributes in the sequence organized by a user according to the preference of the user, and a value obtained by adding the highest weighted values by the number of the sub-attributes included in the preference attribute.

In this case, the loyalties of the sub-attributes can be produced by adding the weighted values to the sub-attributes, which are selected from among all sub-attributes by the user, in the preference sequence for the sub-attributes. In addition, the attribute values of the target to represent the image may be obtained based on a sign, a level numeric value, and a level sign in the same manner as that of the attribute value of the preference image.

That is to say, in the case of a person, the attributes of the target to represent the image may include an outer appearance, and a speech and an action. In the case of products, the attributes of the target may include the quality, the price, the product constitution, the design, the color, the manufacturing, the distribution, the fashion, and the trends. In the case of service, the attributes of the target may include an intangible component, such as consumer surveys or psychological fields. The attributes may be set with several different names according to the application targets.

For example, with respect to the attribute in which the ID code to represent the attribute value of the target image prefers the shape of “F (Form), the value of the attribute is calculated to 2.45 and combined. In this case, the attribute may be expressed as F 2.45. In this case, an ID code can be created with respect to one of the preference image ID codes of the picture or the photo of the elegance or the Diana through the combination of signs, level signs, and level numeric values corresponding to 2.45, F2.45, or F2.45.

The created preference image ID code may be stored in the database 120 of the server 100. Preferably, the created preference image ID code may be stored in the step of storing user authentication and information (S200, see FIG. 2).

Each step is preferably performed by the operation module 104 constituting the system for creating the preference image ID code according to the exemplary embodiment of the present invention. As the operation result, the preference image ID code maybe created (S230), and the step of diagnosing the preference image ID code (S240) maybe performed through the choice of the user.

The step of diagnosing the preference image ID code (S240) is to diagnose whether or not the created preference image ID code is suitable for the user purpose or the user necessity. In this case, the user may respond to the diagnosis result, and may be provided with visualization information of the positioning map according to the multidimensional scaling (MDS) (see FIG. 3C). If the information of the emotional data is visualized through the positioning map, the information of the whole market may be easily compared with the information selected by the user. Accordingly, the public may receive help to determine or compare the preference image ID code.

In this case, the positioning map which serves as visualization information may be transmitted to at least one user terminal module 160 held from the input/output module 102 of the server 100 via the communication network 150.

Next, the step of creating an electronic auxiliary ID code (S250) to supplement the preference image ID code for the preference image ID code created in the above steps may be performed. The electronic auxiliary ID code may further include other individual information such as information of demographic statics, a firm name, a phone number, a serial number of a wire/wireless terminal, an e-mail, URL information, and sequential emotion information of a user for the creation and the storage thereof.

The electronic auxiliary ID code may be stored in the database 120 of the server 100, and may be transmitted to at least one user terminal module 160 through the communication network 140.

Thereafter, after the step of creating an electronic auxiliary ID code (S250) has been performed, a step of creating information of the electronic hardware-type or a physically auxiliary signboard, which includes the information of the electronic auxiliary ID code (not shown) may be further performed.

According to the present step, the electronic auxiliary ID code that can be utilized online/offline and serve as software-type information, which further includes the information of the sequence of the same preference images as that of the preference image ID code in addition to the created preference ID code, can be created, the information of a hardware-type auxiliary signboard or a physically auxiliary signboard including the electronic auxiliary ID code may be created and provided.

In other words, the auxiliary ID code serves as an electronic ID code, such as a bar code, a QR code, a smart code, or an RFID, and is created in the form of software and hardware. According to the present invention, a hardware-type auxiliary signboard, such as a physical signboard including the information of the electronic hardware-type or physically auxiliary signboard including the information of the electronic auxiliary ID code serving as the software-type information, a smart card allowing the wire/wireless communication, a smart chip, a sensor, or other movable recording media, can be further provided. The hardware-type auxiliary signboard includes an auxiliary signboard provided in the form of the software-type information. Accordingly, when the auxiliary signboard provided in the form of the software-type information is searched, the hardware-type auxiliary signboard may be searched.

Then, the step of creating the compatible ID code (S260) may be performed. In the step of creating the compatible ID code (S260), the compatible ID code is preferably a compatible ID code which is compatible with respect to the preference image ID code created according to an exemplary embodiment of the present invention and a broadly classified image resulting from the preference image ID code while taking into consideration images and categories in the same category or different categories.

For example, a representative image of “Modern” to represent the emotional product may be created by a compatible ID code compatible with “Simple” and “Easy” that can be extracted from clothes, cosmetics, or machineries serving as functional products which belong to the same category.

Further, the image of “Modern” for a dress shirt may be created as the compatible ID code compatible with the image of “Simple” for the refrigerator.

Preferably, the preference image ID code, which is created by the system for creating the preference image ID code according to an exemplary embodiment of the present invention, the diagnose result of the preference image ID code, the electronic auxiliary ID code, the information of the electronic hardware-type or physically auxiliary signboard including the information of the electronic auxiliary ID code and the compatible ID code are preferably stored, registered, and managed in the user authentication and information storage module 106.

If the preference image ID code is created according to the present invention, the image characteristic or the image style of a person can be determined. Further, in the case of a product or a brand, the attributes of a store, a shop, a brand, or other various intangible services having enhanced attributes can be segmented to be differentiated or specified in detail.

According to the present invention, the preference image may represent the characteristic and the concept of the image and the concept of a style. The preference image ID code created using the preference image may have the same meaning as that of the preference ID code, the preference concept code, the preference code, the style ID code, the style code, and the style concept code.

In addition, a mark to represent the directionality of a virtual line of the created preference image ID code and the created preference image ID code may be expressed in foreign languages, such as Diana, a, or β, or Korean.

Hereinafter, description will be made with reference to FIGS. 3a to 3c with respect to images of a coordinate axis and collected preferences, a clustered image, a broadly classified image created based on the clustered image, a mark to represent a virtual line and the directionality of the virtual line, and an image to extract the attribute value from the preference image.

FIG. 3a illustrates a plot showing the coordinate axis and the collected preference image provided through the method of creating the preference image ID code according to the exemplary embodiment of the present invention. FIG. 3b illustrates images clustered through the method of creating the preference image ID code according to the exemplary embodiment of the present invention. FIG. 3c illustrates the broadly classified image created based on the clustered image, and an image to set the mark to represent the virtual line and the virtual line directionality, and to extract the attribute value of the preference image through the method of creating the preference image ID code according to the exemplary embodiment of the present invention.

In detail, FIG. 3a is a view showing a plurality of preference images (see reference numeral 300) input in the step of clustering image information to provide a coordinate image (S221) and the step of collecting and inputting an image (S214) shown in FIG. 2. FIG. 3b is a view showing that preference images are collected and clustered into two emphasized preference images 320 and 340 as the number of the preference images are specified. FIG. 3c is a view showing the mark to divide the broadly classified images, which are created in the step of creating a broadly classified image in the structure of the positioning map (S223) and the step of setting the virtual line (S224) shown in FIG. 2, in half, to segment the broadly classified images, and to serve as a mark to represent left and right directionalities.

In this case, various marks sufficient to represent the directionalities and to differentiate opposite characteristics. For example, the marks may include alpha (a)/beta (β), +/−, a/b, O/X, or ←/→.

The setting of the virtual line and the marking of the directionality of the virtual line are performed to make the position of the preference image clear by simplifying the coordinate axis of the professional and segmented term to set the virtual line, and to use the position mark instead of a name that may be publicly used. In addition, the virtual line and the mark to represent the virtual line are preferably applied in the same direction with respect to whole coordinates.

In the step of calculating an attribute value of the preference image (S225, see FIG. 2), the preference images created by the specified number of the preference images are matched with coordinates based on a Euclidean distance value. The attribute values of the preference image are extracted based the attributes by analyzing the broadly classified image. If two preference images (see reference numerals 320 and 340 of FIG. 3b) are created, the preference image, in which the characteristic of the broadly classified image is more emphasized, can be distinguished based on comparison attribute values of the broadly classified image. In addition, the numeric values of the created attributes may be expressed using a sign, a level numeric value, and a level sign so that the numeric values of the created attributes are not excessively segmented.

Accordingly, for example, as shown in FIG. 3c, in the case of reference numerals 320 and 340 to represent “Elegance”, the attribute value of the image of “Elegance” which is a broadly classified image is set to 20, and the attribute values of reference numbers 320 and 340 are set to 9 or 5.5. In this case, on the assumption that the attribute value of the “Elegance” is 100, the attribute values of reference numbers 320 and 340 may have 45 and 27.5, respectively. Accordingly, reference number 320 may be more elegance than that of reference number 340. In addition, reference numbers 320 and 340 may have the attribute value of 4.5 and 2.75, respectively.

The above description is provided for illustrative purpose, and the comparison attribute values can be calculated through various schemes.

In addition, when the preference image is overlapped with the virtual line and positioned (reference number 360, see FIG. 3c), the position of the preference image is determined, and the category of the virtual line image is determined for the comparison value of low-level attributes of the targets to represent the left and right classified images and the image.

The present invention can be provided through a system or a method of providing information using the above preference image ID code. In this case, the preference image ID code may be created by an independent system. That is to say, in the server that exists in the system for providing information according to an exemplary embodiment of the present invention, the preference ID code can be created. Alternately, the preference image ID code maybe created in the additional external server. In this case, the server for creating the preference image ID code may be referred to as a preference image ID code creating server. In addition, the server 100 according to the present invention may be a single server, or may be an integrated-type server that a plurality of servers are integrated with each other.

Similarly, the configuration of the system including the server 100 including the input/output module 102, the operation module 104, and the user authentication and information storage module 106, the database 120, and the user terminal module 160 may be realized using another system having the same specifications.

In addition, the system for creating the preference image ID code according to the exemplary embodiment of the present invention may further include a user authentication and information storage server or may further perform a user authentication and information storage step. In addition, the system for providing information according to the present invention may further include the user authentication and information storage server or further perform the user authentication and information storage step. In addition, the user authentication and information storage server may be separately constructed in the outside.

The system for providing information according to the exemplary embodiment of the present invention may be realized in the form of a system similar to the system for creating the preference image ID code shown in FIG. 1. Accordingly, the system for providing information according to the exemplary embodiment of the present invention may not be shown.

The system for providing information according to the present invention may provide location-based information by combining and creating the preference image ID code (see S230 of FIG. 2) after the user accesses the server 100 through at least one user terminal module 160, and using the created preference image ID code.

In this case, at least one user terminal module 160 accessing the server 100 may preferably provide location-based information and the like. The at least one user terminal module 160 preferably accesses the input/output module 102 of the server 100 through the wire/wireless communication network 140 including the Internet network or the Intranet network.

In this case, the user terminal module 160 may include a terminal device that can display data, especially a web site (or home page), transmitted through the communication network 140, and can employ all input schemes through a keyboard, a mouse, a touch, and a voice so that bi-directional communication can be made. For example, the user terminal module 106 may be realized in the form of a general computer (PC) or a laptop computer, or may include an IPTV, various kinds of game machine, a portable terminal realized in the form of a cellular phone, a smart phone, or a tablet, and other dedicated terminals.

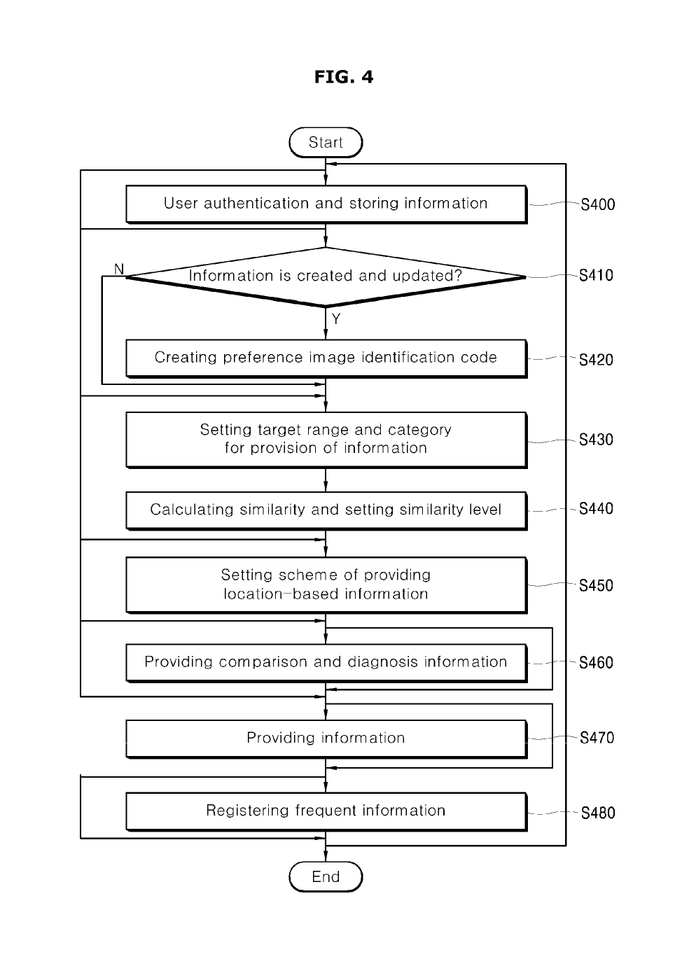

Hereinafter, various method of utilizing the preference image ID code for information search and/or location-based information will be described with reference to FIG. 4.

FIG. 4 is a flowchart schematically showing a method of providing information according to an exemplary embodiment of the present invention.

The method of providing the information of FIG. 4 may include a user authentication and information storage step (S400), a step of creating and updating information (S410), a step of creating the preference image ID code (S420), a step of setting target range and category for the information provision (S430), a step of calculating similarity and setting a similarity level, a step of setting a scheme of providing location-based information (S450), a step of providing information for comparison diagnosis (S460), a step of providing information (S470), and a frequent information registering step (S480).

In this case, the user can directly search for an emotional word, an association word, or an image representing the preference image ID code, which has been already crated, through the access to the server 100 without the above steps, or through the server 100 after the step of storing the user authentication and information (S400) has been performed.

Accordingly, the user may memorize the preference image ID code or may directly search for the preference image ID code in the step of storing user authentication and information (S400) and then may directly search for, for example, the preference image ID code associated with “Elegance”. Accordingly, the user may search for the preference image ID code associated with

“Elegance” by searching for an Elegance coat, James bond glasses, other specific photos, other specific pictures, or hats belonging to the corresponding category.

Hereinafter, the sequence in the method of providing information using the preference image ID code according to the exemplary embodiment of the present invention will be described in detail. In the user authentication and information storage step (S400), the demographic information of the user, other relevant firm names, a phone number, the number of wireless/wire terminals, an e-mail, and an URL may be received through the user terminal module 160. In addition, the preference image ID code, the electronic auxiliary ID code, the information of the electronic hardware type or a physically auxiliary signboard, which includes the information of the electronic auxiliary ID code, and comparison and diagnosis results, which are created in steps (S230 to S260) of FIG. 2, may be registered and stored in the user authentication and information storage module 106.

The step of creating and updating information (S410) is to allow a user accessing the system for creating the preference image ID code to update or create the preference image ID code which has been created. According to the present step (S410), if the creation or the update of information is not required, the step of setting target range and category for the information provision (S430) can be immediately performed. In this case, since the registration of the information may be processed according to the method of creating the preference image ID code described with reference to FIG. 2, the details thereof will be omitted.

The step of creating the preference image ID code (S420) is preferably a step to progress according to the method of creating the preference image ID code as described with reference to FIG. 2. The details of the present step (S410) will be omitted because the present step (S410) has the same description as that of FIG. 2.

Next, in the step of setting target range and category for the information provision (S430), the target range for the provision of the information may represent the targets for the provision of the information in a tangible/intangible product including a person, a store, or a brand. The category for the provision of the information may represent attributes, such as demographic factors, a part number, and an item, constituting the target or the sub-attributes of the target, and at least one of them may be specified.

In other words, the attribute of the target does not represent the attribute of an image, but, for example, may represent the shape, the color, the material, or the pattern serving as an elegance image code. The information of the target according to the present invention may be input through the step (S210) of inputting the information of the image of FIG. 2. In this case, as described above, the code may be created through the step of creating factors constituting the preference image (S220) and the step of creating factors constituting the preference image (S220). The target range and the category for the provision of the information are determined, so that the combination information between targets, such as persons having similar preferences, a person and a product, a person and a service, products, a product and a service, and services may be requested and received.

For example, the target range for the provision of the information is set to “store”, and the category for the provision of the information is set to at least one of emotional, functional, and service products using the preference image ID code received by the user. Then, if cloths or accessories are selected among the emotional products in more detail, or the emotional products are selected according to genders and ages, the information of an image related to “Store”-->“Clothes”-->“Accessories”-->“Adolescents”, which is matched with the preference image ID code of the user may be requested.

However, in this case, the number of the requested information may be excessively increased depending on the target range for the provision of the information. Accordingly, preferably, in order to provide more integrated information, a step of calculating and setting similarity (S440) may be further provided.

The similarity between a target for the information request and a target for the provision of the information is calculated based on the preference image ID code through various schemes. The scheme of calculating the similarity may include a vector space model (VSM). The details of the scheme of calculating the similarity will be omitted below.

Regarding the similarity and the similarity level, for example, if total 90 pieces of image information similar to that of a specific preference image ID code matched with a specific range and a specific category are found out, and if image information corresponding to at least 50% of the similarity level is selected, the user may be provided with total 45 pieces of information.

In this case, when the information of the target is set in five levels, the number of the filtered target information may be provided corresponding to first to fifth levels. Five, six, nine, four, ten, and 15 pieces of target information are provided for the first to fifth levels, respectively. In this case, the user determines the number of the target information included in each similarity level. When the similarity level is set and the number of information is determined for the information provision, the time and the effort of the user can be saved.

Further, in order to provide the more integrated information, a method of providing detailed information of location-based information is set after the similarity level has been set (S450). When the location-based information is provided, the user may set a region, that is, a close region, or other regions. The close region may refer to a region in which a user is currently positioned, and other regions may refer to regions stored in the database.

In addition, the information of domestic and foreign regions may be requested according to the regions stored in the database. For example the search of a person, a store, and a service in a region A, B, or C having the information of a target matched with the preference image ID code of the information request target may be requested.

Although the present invention has been description only of the method of providing location-based information for the setting of the similarity level, various methods of providing information may be provided. In other words, the preference image ID code maybe directly searched for the provision of the information or comparison diagnosis information maybe provided by diagnosing the preference image ID code for the information provision. The direct search based the preference image ID code is similar to a search method using a typical search engine.

The preference image ID code created in FIGS. 1 and 2 can be utilized as an electronic auxiliary ID code (see step S250 of FIG. 2). Accordingly, sequences are assigned to the same preference image ID codes to conveniently differentiate the same information, especially to easily candidate the information of franchises. For example, the signboard of a ladies wear shop named “Agnes” may be set to have the image preference of “Elegance”, so that the Elegance may be utilized for other physically auxiliary signboards such as an Elegance Alpha Gangnam, or an Elegance alpha hongdae 13.

The hardware-type auxiliary signboard containing the electronic auxiliary ID code having the image preference code may be attached to an internal or external place of the store. When the location-based information is provided, the hardware-type signboard is not limited to only the function as a map, but allows the user to personally visually recognize information in a field in which the user is located, so that the hardware-type signboard may serve as a direct information appealing module.

Next, the locate-based information may be provided by selecting at least one of visual and/or acoustic notification modules. For example, when a sensor containing the electronic auxiliary ID code and information including other individual information of the preference image ID code or the compatible ID code in on/off line is attached, so that the sensor serves as a proximity sensor to sense the approach of the user within the distance of 1 m to 3 m, the location-based information may be directly provided to the user immediately before the store suitable for the preference of the user on the assumption that the preference image ID code is set in the portable terminal of the user while the user carelessly passes the store.

In this case, the information may be provided through the portable terminal of the user, and the information of the similarity level is provided as the notification information of each step. The visual sign information representing a step or a level, such as “**”, or “***” and the acoustic notification information of each step can be selectively provided. The method and the type of providing the information may be fixedly used according to the necessities of the user, or may be modified through various schemes whenever the provision of the information is requested.

In the step of providing information for comparison diagnosis (S460), the information matched with the preference image ID code or the similarity level can be provided separately or integrally, and the comparison diagnosis information maybe provided after selecting a method of providing at least one of plural pieces of visual information of an index, a graph, and a positioning map.

For example, when the diagnosis information is provided corresponding to the similarity of the first level, and when the broadly classified image of products, a virtual line and the directionality of the virtual line, an attribute value, the comparison information of the attribute value of the target constituting the image preference image code of a preference store corresponding the similarity of the first level are individually or integrally selected, the diagnosis information corresponding to the similarity of the first level is provided in the form of visually comparable information. The comparison diagnosis information may be provided individually or by selectively setting a visual method or an acoustic method in order to provide the location-based diagnosis information.

As described above, according to the present invention, factors are extracted from the preference image ID code crated in the process of clustering conventional processes of creating preference images extracted based on individual feelings and schematizing the conventional processes in the form of a positioning map, thereby creating the preference image based on reasonable grounds, so that the preference image ID code can be crated. In addition, a diagnosis method including the visible information to diagnose the created preference image ID code can be provided, so that the convenience of the user can be more improved.

In addition, the created preference image ID code, which serves as preference information of a target that can be semi-fixedly utilized, provides a user with convenience that basic information is not provided whenever the information is requested. In addition, the created preference image ID code is segmented, so that the information of the target can be differentiated. Alternatively, the created preference image ID code may be newly created always according to the selection of the user.

The created preference image ID code contains the sequence of the same preference images, so that the created preference image ID may be utilized as an auxiliary signboard including the electronic auxiliary ID code. Accordingly, the created preference image ID may be used for direct/indirect information transmission and designated even in the saturated environment that various products, various custom preferences, a dense area in which a plurality of online or offline stores exist, a plurality of online communities.

In addition, the information may be received by searching for various preference image ID codes and the compatible ID code, which are created using the preference image ID code, and the electronic auxiliary ID code. The location-based information can be received using the electronic auxiliary ID code, a hardware-type auxiliary signboard, such as a sensor, or a physically auxiliary signboard including software-type information through the visible scheme and/or the acoustic scheme used for the notification at each step according to the similarity level. In addition, since the comparison diagnosis information used to compare and diagnose the preference image ID code can be selected and provided, various schemes of receiving information may be employed according to the information request objects and the needs of the user.

In addition, the location-based information according to the present invention may be provided using a map service, for example, a map service provided from domestic or foreign portal sites, such as Google, or a location-based service cooperating with the map service.

Finally, the frequency information registering step (S480) is a step to register image information, which is provided in a method of providing at least one of the location-based information and/or the comparison diagnosis information, as frequent information when the image information satisfies a user. In this case, preferably, the user expresses the intensions of the user related to the satisfaction through at least one user terminal module 160. In this case, the frequent information may be stored in the user authentication and information storage module 106.

Further, after the frequent information registering step (S480), the user selectively returns to the user authentication and information storage step (S400) to perform each step of FIG. 4 according to an exemplary embodiment of the present invention.

Although a preferred embodiment of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICABILITY

Accordingly, the differentiated, segmented, semi-fixed preference image identification code is created, thereby creating the identification code that can be easily determined the preference of the target and designated. Accordingly, the preference image identification code can be utilized as personal and individual information for a predetermined period of time, so that the preference image identification code can be usefully used in E-commerce, marketing, and content fields.

In addition, a person and a company can reasonably create the preference image identification code, so that the creation result can be conveniently provided as information or verified and diagnosed in the form of visual information.

In addition, information can be received by utilizing the created preference image identification code as a search word, and the auxiliary signboard of the store including the electronic auxiliary identification code is created by utilizing the preference image identification code, in the saturated environment that various products, various custom preferences, a dense area in which a plurality of online or offline stores exist, a plurality of online communities, so that information can be directly requested.

Further, the location-based information and comparison and diagnosis information including a step-by-step notification service based on a similarity level matched with the preference image identification code can be received, so that the differentiated and customized information can be received.

1. A method of creating a preference image identification code in a system for creating the preference image identification code, which includes at least one server having an input/output module and an operation module, a database connected with the at least one server to serve as a user authentication and information storage module, at least one user terminal, and a wire/wireless communication network to connect the at least one server with the at least user terminal, the method comprising:
(A) allowing the at least one server to receive information of each of the at least one user terminal from the at least user terminal through the input/output module, perform user authentication, and store relevant information in the database;
(B) allowing the at least one server to receive a target range and a category for information provision set based on information of a tangible/intangible product target including a person, a store, or a brand and related to the preference image identification code to be created and information of a component of the target from the at least one user terminal through the input/output module;
(C) allowing the at least one server to collect at least one image information of an emotional word, an association word associated with the emotional word, and an image from the at least one server or the at least one user terminal based on the target range and the category;
(D) allowing the operation module to cluster the collected image information on a positioning coordinate image, to position a preference image on the coordinate image having clustering, and to determine the position of the preference image; and
(E) allowing the operation module to create the preference image identification code from the positioned preference image and to store the preference image,
wherein, in the step (C), the image information is collected through at least one input scheme among an input based on a question or a questionnaire, an input based on a bar code, and at least one of a two dimensional code or a three dimensional code, and an input by the at least one server or the at least one user terminal.

2. The method of claim 1, further comprising (F) receiving a number of preference images to be created from the at least one user terminal between the steps (C) and (D).

3. The method of claim 2, wherein the step (E) comprises allowing the operation module to create the preference image identification code by extracting at least one broadly classified image, which serves as a representative image of a coordination axis closest to coordinates of the positioned preference image and is determined using at least one of the emotional word, the association word associated with the emotional word, and the image, a virtual line mark to represent virtual line setting and a virtual line directionality, an attribute value of the preference image, and an attribute of the target from the positioned preference image and then by combining at least one of them with each other.

4. The method of claim 3, further comprising (G) creating a compatible identification code compatible with the preference image in the set category based on the created preference image identification code, and creating at least one of an electronic auxiliary identification code including at least one individual identification information of the tangible/intangible product including the person, the store, and the brand, and auxiliary signboard information utilized online/offline, and serving as electronic auxiliary identification code information including the electronic auxiliary identification code, from the preference image identification code or the compatible identification code.

5. A method of diagnosing a preference image identification code created through the creating of the preference image identification code of claim 4, wherein the operation module provides at least one of information of at least one of the created preference image identification code, the electronic auxiliary identification code, the auxiliary signboard, and the compatible identification code and visualization information of the information to the user terminal such that the at least one of the created preference image identification code, the electronic auxiliary identification code, the auxiliary signboard, and the compatible identification code is diagnosed in the user terminal.

6. The method of claim 5, wherein diagnosis information of the preference image identification code is stored in the database of the at least one server.

7. A method of creating a preference image identification code in a system for creating the preference image identification code, which includes at least one server having an input/output module and an operation module, a database connected with the at least one server to serve as a user authentication and information storage module, at least one user terminal, and a wire/wireless communication network to connect the at least one server with the at least user terminal, the method comprising:
(A) allowing the at least one server to receive information of each of the at least one user terminal from the at least user terminal through the input/output module, perform user authentication, and store relevant information in the database, to input a target range and a category for information provision set based on information of a tangible/intangible product target including a person, a store, or a brand and related to the preference image identification code to be created and information of a component of the target from the at least one user terminal through the input/output module, and to collect at least one image information of an emotional word, an association word associated with the emotional word, and an image from the at least one server or the at least one user terminal based on the input target range and the category; and
(B) allowing the operation module to cluster the collected image information on a positioning coordinate image, position a preference image on the coordinate image having cluster, and determine the position of the preference image, and to create the preference image identification code from the positioned preference image and store the preference image,
wherein the image information is collected through at least one input scheme among an input based on a question or a questionnaire, an input based on a bar code, and at least one of a two dimension code or a three dimension code, and an input by the at least one server or the at least one user terminal.
